(19) United States
(12) Patent Application Publication
(10) Pub. No.: US 2017/0149119 A1
(43) Pub. Date: May 25, 2017

(54) METAL HOUSING FOR ELECTRONIC COMMUNICATION DEVICE AND MANUFACTURING METHOD THEREOF

(71) Applicant: Xiaomi Inc., Beijing (CN)

(72) Inventors: Jianyu WANG, Beijing (CN); Zhuxin LI, Beijing (CN); Guohua WANG, Beijing (CN)

(73) Assignee: Xiaomi Inc.

(21) Appl. No.: 15/422,023

(22) Filed: Feb. 1, 2017

Related U.S. Application Data
(63) Continuation of application No. PCT/CN2015/097799, filed on Dec. 18, 2015.

(30) Foreign Application Priority Data
Dec. 18, 2014 (CN) 201410800392.X
Jun. 2, 2015 (CN) 201510296630.2

(51) Int. Cl. H01Q 1/24; H04M 1/02

(52) U.S. Cl. CPC H01Q 1/243; H04M 1/0202

(57) ABSTRACT

A metal housing of an electronic communication device includes: a metal frame, and a plurality of micro holes. At least some of the plurality of micro holes penetrate the metal frame, with the plurality of micro holes being arranged into at least two rows to form a strip.

### CROSS-REFERENCE TO RELATED APPLICATIONS

The present application is a continuation of International Application No. PCT/CN2015/097799, filed Dec. 18, 2015, which is based upon and claims priority to Chinese Patent Application No. 201410800392.X, filed Dec. 18, 2014 and Chinese Patent Application No. 201510296630.2, filed Jun. 2, 2015, the entire contents of all of which are incorporated herein by reference.

### TECHNICAL FIELD

The present disclosure relates to the technical field of electronic communication devices and, more particularly, to a metal housing for an electronic communication device, and a manufacturing method thereof.

### BACKGROUND

Currently, it is common for an electronic communication device, such as a mobile phone, to include a metal housing. Such a device typically has an internal antenna enclosed by the metal housing. A high electrical conductivity of the metal house can adversely affect the radiation of the signals of the antenna. To reduce electrical conductivity of the metal house, the metal housing is typically partitioned into several portions, with each portion connected by plastics formed with injection molding. However, with the metal housing not being an integral piece, the structural strength of the metal housing, as well as its appearance, can be compromised.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one aspect, a metal housing of an electronic communication device is provided. The metal housing comprises: a metal frame; and a plurality of micro holes; wherein at least some of the plurality of micro holes penetrate the metal frame, the plurality of micro holes being arranged into at least two rows to form a strip.

In another aspect, a method for manufacturing a metal housing is provided. The method comprises: forming a metal frame; and forming a plurality of micro holes; wherein at least some of the plurality of micro holes penetrate through the metal frame; wherein the plurality of micro holes are arranged in at least two rows to form a strip.

It should be understood that both the foregoing general description and the following detailed description are only exemplary and are not restrictive of the invention.

### BRIEF DESCRIPTION OF THE DRAWINGS

The accompanying drawings, which are incorporated in and constitute a part of this specification, illustrate embodiments consistent with the invention, and together with the description, serve to explain the principles of the invention.

FIG. 1 is a structural schematic diagram illustrating a metal housing of an electronic communication device, according to an exemplary embodiment.

FIG. 2A is an enlarged view of a metal frame as shown in FIG. 1.

FIG. 2B is another enlarged view of a metal frame as shown in FIG. 1.

FIG. 3 is a schematic diagram illustrating an exemplary placement of micro holes with respect to an antenna of an electronic communication device, according to an exemplary embodiment.

FIGS. 4 and 5 are schematic diagrams illustrating exemplary placement of micro holes on the metal housing of an electronic communication device, according to an exemplary embodiment.

FIG. 6 is a structural schematic diagram illustrating another metal housing of an electronic communication device, according to an exemplary embodiment.

FIG. 7 is another view of the metal housing of FIG. 6

FIG. 8 is a block diagram of an electronic communication device in which embodiments of the present disclosure can be implemented.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

The embodiments of the present disclosure provide a metal housing that can be used for an electronic communication device. The electronic communication device may have a communication function, such as a mobile phone, a tablet, a laptop computer, a router, and a camera device, and the electronic communication device may include an internal antenna, such as a GPS (Global Positioning System) antenna, and a WiFi antenna, for the communication function.

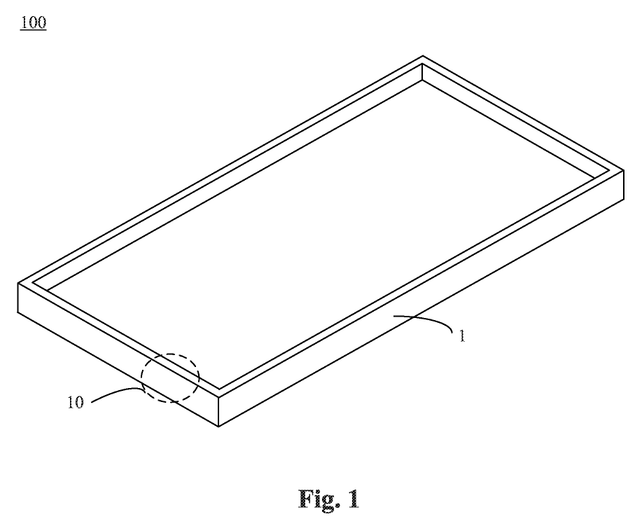

FIG. 1 is a structural schematic diagram illustrating a part of a metal housing 100 of an electronic communication device, according to an exemplary embodiment. The metal housing 100 includes a metal frame 1. Metal frame 1 also includes a portion 10 which includes a plurality of micro holes.

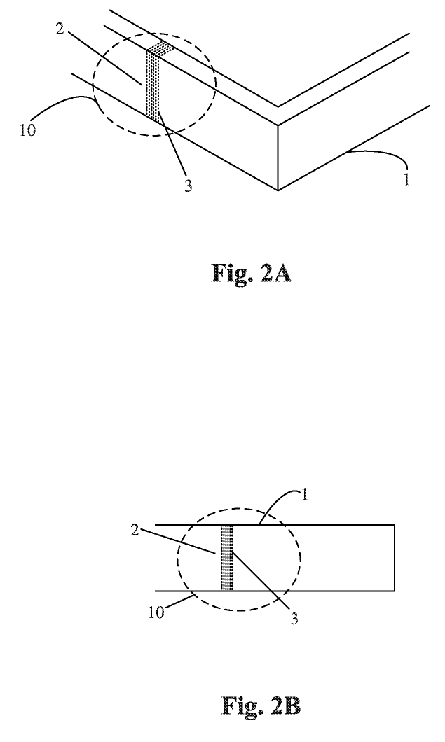

Reference is now made to FIG. 2A and FIG. 2B, which illustrate an enlarged view of portion 10. FIG. 2A illustrates an enlarged perspective view of portion 10, while FIG. 2B illustrates an enlarged side view of portion 10. As shown in FIG. 2A, a strip 2 is formed on the metal frame 1. The strip 2 includes a plurality of micro holes 3 that penetrate the metal frame 1, which can reduce a cross sectional area of the metal frame 1 for electrical conduction, and the electrical conductivity of the metal frame 1 can thereby be reduced. The micro holes 3 may be of any shape, such as a circle, an oblong, and a rectangle. A size of the micro holes 3 may be predetermined based on various criteria, such as to reduce electrical conductivity of the metal frame 1 and to reduce the visibility of the micro holes 3. For example, a length of each micro hole 3 may be less than 0.1 mm.

With embodiments of the present disclosure, a metal frame (and/or a metal back plate) of a metal housing can include a plurality of micro holes that penetrate the metal frame. In a case where the metal frame surrounds an antenna, since the electrical conductivity of the metal frame is reduced as a result of these micro holes penetrating through the metal frame, the effect of the metal frame on the radiation of the antenna signals can be reduced, and the antenna performance of an electronic communication device including the metal frame can be enhanced. Furthermore, since the metal frame remains an integral piece, the structural strength of a metal housing including the metal frame, as well as its appearance, can be improved.

In some embodiments, the plurality of micro holes can be formed by directing one or more laser beams on an outside surface of the metal frame.

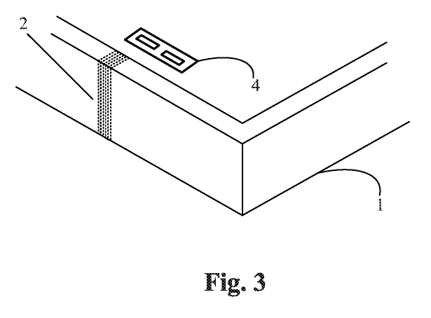

In some embodiments, the strip 2 may be positioned based on a location of the antenna relative to the metal frame. For example, as shown in FIG. 3, an antenna 4 is disposed within a space surrounded by the metal frame 1. A position of the strip 2 on the metal frame 1 can be determined such that it corresponds to a signal radiation position of the antenna 4, to improve the signal radiation performance of the antenna 4.

Further, generally the metal housing of an electronic communication device, such as a mobile phone, and a tablet, etc., may include at least one of a metal frame (e.g., the metal frame 1) and a metal back plate. The antenna of the electronic communication device may be either close to the metal frame, or provided on an inside surface of the metal back plate. To facilitate the performance of the antenna, the strip may be formed on the metal frame, or on the metal back plate. The strip may also be formed on both the metal frame and the metal back plate, or at any pre-determined position of the metal housing based on application need.

As an illustrative example, a metal frame 1 can comprise at least two strips 2, with each strip including a plurality of micro holes. With such an arrangement, the electrical conductivity of the metal frame 1 can be reduced, and the signal radiation of the antenna, as well as its performance, can be enhanced. In addition, a size of the strip 2 can be determined based on a degree of coupling between antenna signals, the signal intensity of the antenna, etc.

In some embodiments, in a case where the metal frame 1 comprises at least two strips 2, a part of the metal frame 1 between two adjacent strips may be used to form a part of the antenna in the electronic communication device. In a case where the metal back plate comprises at least two strips 2, a part of the metal back plate between two adjacent strips 2 may also be used to form a part of the antenna in the electronic communication device. Further, a shape of a portion of the metal back plate between two strips 2 may match with a shape of the antenna, which may be of, for example, a ring shape, a T shape, etc.

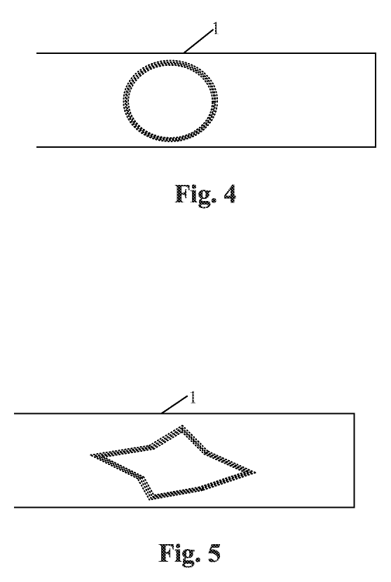

In some embodiments, as shown in FIG. 2A, a shape of the strip 2 on the metal frame 1 may be designed to be of any shape as needed, such as an oblong (such as shown in FIG. 2A or FIG. 2B), a circular ring (as shown in FIG. 4), or any other pre-determined shape (such as shown in FIG. 5, but not limited to the shape shown in FIG. 5).

In addition, the micro holes 3 may be aligned into one or more rows, as shown in FIGS. 2A, 2B, 4, and 5. The rows can be parallel to each other. The distances between respective rows of the micro holes 3 need not be uniform and may be application specific. For example, the distances between respective rows of the micro holes 3 may be uniform, which can be convenient to manufacture, or may be non-uniform.

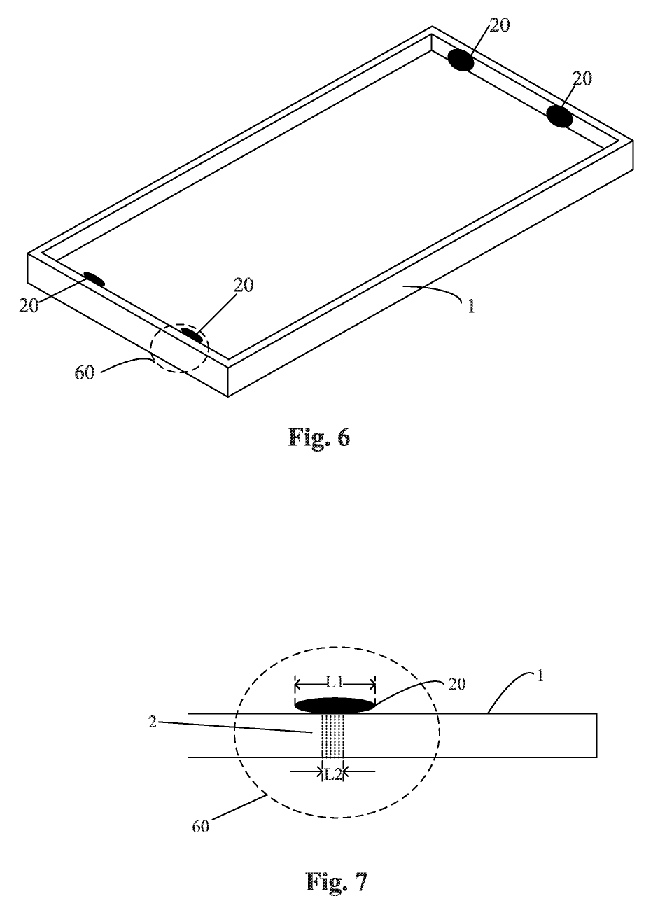

In some embodiments, in order to increase the structural strength of the metal frame 1, a support member can be disposed on portions the metal frame that correspond to the strip 2. FIG. 6 and FIG. 7 illustrate a metal housing that includes one or more support members, according to embodiments of the present disclosure. FIG. 6 provides a perspective view of the metal frame 1 with the support members, while FIG. 7 illustrates an enlarged side view of the metal frame 1 with the support members of FIG. 6.

For example, as shown in FIG. 6 and FIG. 7, a support member 20 may be provided on a portion 60 of the inside surface of the metal frame 1 that includes the strip 2. In a case where the metal frame 1 includes a plurality of strips 2, a support member 20 is provided for each of the plurality of the strips 2. The support member 20 can be configured to increase the structural strength of the metal frame 1, such as at the locations of the strips 2. Further, in order not to affect the electrical conductivity of the metal frame 1 (and the performance of the antenna surrounded by the metal frame 1), the support member 20 may be made of an insulation material. In addition, the sizes of the support members are usually larger than the sizes of the strip, to improve the structural strength. For example, as shown in FIG. 7, the width of the support member 20, which is L1, is larger than the width L2 of the strip 2.

In some embodiments, to increase the stability of the strip 2, and to increase the strength of the metal housing, the plurality of micro holes 3 are filled with insulation filler. The insulation filler may include particles made of any material that can provide electrical insulation. In some embodiments, the aforementioned support members can be integrally formed with the insulation filler.

Embodiments of the present disclosure also provide a method for manufacturing a metal housing for an electronic communication device. The method may include: forming a plurality of micro holes that penetrate through at least a part of the metal housing, wherein the plurality of micro holes form a strip. The strip can be formed on at least one of a metal frame and a metal back plate of the metal housing.

There are various methods of forming the micro holes. For example, using micro perforation technology, the metal housing can be formed using injection molding. The at least a part of the metal housing (e.g., the metal frame, the metal back plate, etc.), on which the micro holes are to be formed, can be connected with plastic, and the micro holes can be formed by punching the metal housing. As another example, a plurality of micro holes may also be formed by laser on an outside surface of the metal frame and/or the metal back plate.

In some embodiments, the method may further include: providing a support member on an inside surface of the metal frame and/or the metal back plate that includes the plurality of the micro holes. The support member may include, for example, the support member 20 of FIGS. 6 and 7, the details of which are not repeated herein.

In some embodiments, the method further comprises: filling the plurality of micro holes with insulation filler. The insulation filler may include particles made of any material that can provide electrical insulation. The filling of the insulation filler can be performed by, for example, squeezing an insulation material against the outside surface of the metal frame and/or metal back plate that includes the plurality of micro holes, to cause the insulation material to enter into the plurality of micro holes to form the insulation filler, and to spread onto the inside surface of the metal frame and/or the metal back plate. The insulation material that spreads onto the inside surface forms the insulation support member for the strip that includes the plurality of the micro holes.

With embodiments of the present disclosure, a metal frame (and/or a metal back plate) of a metal housing can include a plurality of micro holes that penetrate the metal frame. In a case where the metal frame surrounds an antenna, since the electrical conductivity of the metal frame is reduced as a result of these micro holes penetrating through the metal frame, the effect of the metal frame on the radiation of the antenna signals can be reduced, and the antenna performance of an electronic communication device including the metal frame can be enhanced. Furthermore, by, optionally, filling the micro holes with insulation material and disposing one or more support members at the strips of the metal frame that comprise the micro holes, the structural strength of the metal frame can be improved. Since the metal frame appears as an integral piece, its appearance can be improved as well.

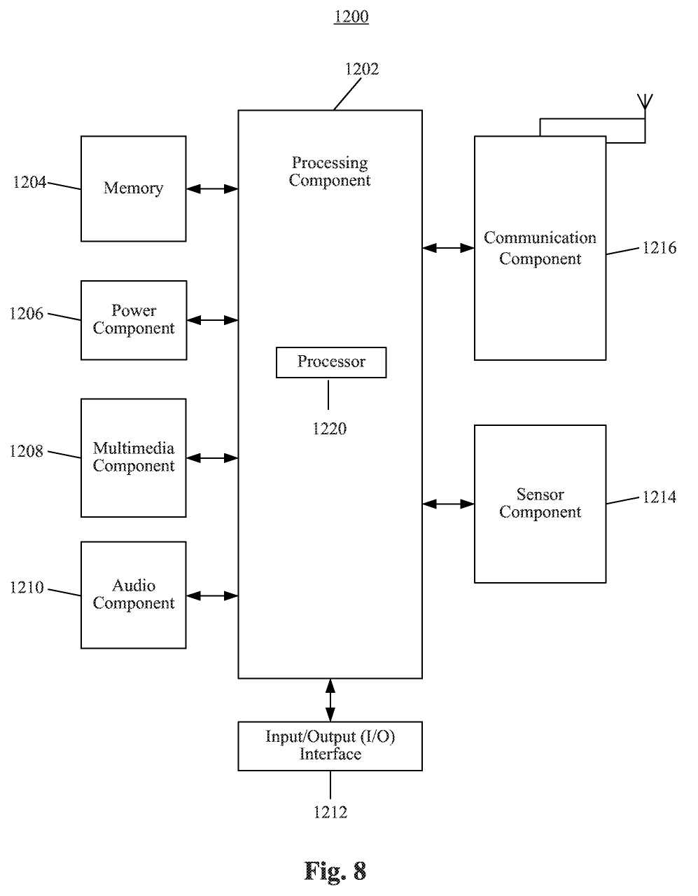

FIG. 8 is a block diagram applicable for an electronic communication device 1200 having a metal housing, according to an exemplary embodiment. The electronic communication device 1200 may be a mobile phone, a computer, a digital broadcast terminal, a messaging device, a gaming console, a tablet, a medical device, exercise equipment, a personal digital assistant, and the like.

Referring to FIG. 8, the electronic communication device 1200 may include one or more of the following components: a processing component 1202, a memory 1204, a power component 1206, a multimedia component 1208, an audio component 1210, an input/output (I/O) interface 1212, a sensor component 1214, and a communication component 1216.

The processing component 1202 typically controls overall operations of the electronic communication device 1200, such as the operations associated with display, telephone calls, data communications, camera operations, and recording operations. The processing component 1202 may include one or more processors 1220 to execute instructions to perform all or part of the steps in the above described methods. Moreover, the processing component 1202 may include one or more modules which facilitate the interaction between the processing component 1202 and other components. For instance, the processing component 1202 may include a multimedia module to facilitate the interaction between the multimedia component 1208 and the processing component 1202.

The memory 1204 is configured to store various types of data to support the operation of the electronic communication device 1200. Examples of such data include instructions for any applications or methods operated on the electronic communication device 1200, contact data, phonebook data, messages, pictures, video, etc. The memory 1204 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1206 provides power to various components of the electronic communication device 1200. The power component 1206 may include a power management system, one or more power sources, and any other components associated with the generation, management, and distribution of power in the electronic communication device 1200.

The multimedia component 1208 includes a screen providing an output interface between the electronic communication device 1200 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1208 includes a front camera and/or a rear camera. The front camera and the rear camera may receive an external multimedia datum while the electronic communication device 1200 is in an operation mode, such as a photographing mode or a video mode. Each of the front camera and the rear camera may be a fixed optical lens system or have focus and optical zoom capability.

The audio component 1210 is configured to output and/or input audio signals. For example, the audio component 1210 includes a microphone configured to receive an external audio signal when the electronic communication device 1200 is in an operation mode, such as a call mode, a recording mode, and a voice recognition mode. The received audio signal may be further stored in the memory 1204 or transmitted through the communication component 1216. In some embodiments, the audio component 1210 further includes a speaker to output audio signals.

The I/O interface 1212 provides an interface between the processing component 1202 and peripheral interface modules, such as a keyboard, a click wheel, buttons, and the like. The buttons may include, but are not limited to, a home button, a volume button, a starting button, and a locking button.

The sensor component 1214 includes one or more sensors to provide status assessments of various aspects of the electronic communication device 1200. For instance, the sensor component 1214 may detect an open/closed status of the electronic communication device 1200, relative positioning of components, e.g., the display and the keypad, of the electronic communication device 1200, a change in position of the electronic communication device 1200 or a component of the electronic communication device 1200, a presence or absence of user contact with the electronic communication device 1200, an orientation or an acceleration/deceleration of the electronic communication device 1200, and a change in temperature of the electronic communication device 1200. The sensor component 1214 may include a proximity sensor configured to detect the presence of nearby objects without any physical contact. The sensor component 1214 may further include a light sensor, such as a CMOS or CCD image sensor, for use in imaging applications. In some embodiments, the sensor component 1214 may further include an accelerometer sensor, a gyroscope sensor, a magnetic sensor, a pressure sensor, or a temperature sensor.

The communication component 1216 is configured to facilitate communication, wired or wirelessly, between the electronic communication device 1200 and other devices. The electronic communication device 1200 can access a wireless network based on a communication standard, such as WiFi, 2G, 3G, or 4G, or a combination thereof. In one exemplary embodiment, the communication component 1216 receives a broadcast signal or broadcast associated information from an external broadcast management system through a broadcast channel In one exemplary embodiment, the communication component 1216 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies. The communication component 1216 may include (or be coupled with) an antenna configured to receive the broadcast signal for the aforementioned standards and technologies.

In exemplary embodiments, the electronic communication device 1200 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is further provided a non-transitory computer-readable storage medium including instructions, such as included in the memory 1204, executable by the one or more processors 1220 in the electronic communication device 1200, for performing the above-described methods. For example, the non-transitory computer-readable storage medium may be a ROM, a RAM, a CD-ROM, a magnetic tape, a floppy disc, an optical data storage device, and the like.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes may be made without departing from the scope thereof. It is intended that the scope of the invention should only be limited by the appended claims.

What is claimed is:

1. A metal housing of an electronic communication device, the metal housing comprising:
a metal frame; and
a plurality of micro holes; wherein at least some of the plurality of micro holes penetrate the metal frame, the plurality of micro holes being arranged into at least two rows to form a strip.

2. The metal housing according to claim 1, wherein
the plurality of micro holes are formed by directing a laser beam onto an outside surface of the metal frame.

3. The metal housing according to claim 1, further comprising:
a support member disposed on an inside surface of the metal frame at a location that corresponds to the strip.

4. The metal housing according to claim 3, wherein
a width of the support member is larger than a width of the strip.

5. The metal housing according to claim 4, wherein
the plurality of micro holes are filled with an insulation filler comprising an electrical insulator material.

6. The metal housing according to claim 5, wherein
the support member comprises an electrical insulator material; and wherein the support member and the insulation filler are integrally formed.

7. The metal housing according to claim 1, wherein
the at least two rows of the plurality of micro holes are parallel to each other.

8. The metal housing according to claim 1, wherein
the metal frame surrounds an antenna of the electronic communication device; and
a position of the strip on the metal frame corresponds to a signal radiation position of the antenna.

9. The metal housing according to claim 1, wherein
the metal housing further comprises a metal back plate; and
at least some of the plurality of micro holes penetrate the metal back plate.

10. The metal housing according to claim 9, wherein
the plurality of micro holes on the metal frame are arranged in at least two strips; and
wherein a part of the metal frame between two adjacent strips among the at least two strips forms a part of the antenna for the electronic communication device.

11. The metal housing according to claim 9, wherein
the plurality of micro holes on the metal back plate are arranged in at least two strips; and
wherein a part of the metal back plate between two adjacent strips among the at least two strips forms a part of the antenna for the electronic communication device.

12. The metal housing according to claim 11, wherein
a shape of a portion of the metal back plate between two of the at least two strips matches with a shape of the antenna.

13. A method for manufacturing a metal housing, comprising:
forming a metal frame; and
forming a plurality of micro holes; wherein at least some of the plurality of micro holes penetrate through the metal frame; wherein the plurality of micro holes are arranged in at least two rows to form a strip.

14. The method according to claim 13, wherein the forming a plurality of micro holes comprises:
directing a laser beam onto an outside surface of the metal frame.

15. The method according to claim 13, further comprising:
providing a support member on an inside surface of the metal frame at a location that corresponds to the strip.

16. The method according to claim 15, further comprising:
providing the support member to have a width larger than a width of the strip.

17. The method according to claim 13, further comprising:
filling insulation filler into the plurality of micro holes.

18. The method according to claim 17, wherein the filling insulation filler into the plurality of micro holes comprises:
squeezing an insulation material against the outside surface of the metal frame, to cause the insulation material to enter into the plurality of micro holes to form the insulation filler, and to cause the insulation material to spread onto an inside surface of the metal frame to form a support member.
